(19) United States
(12) Patent Application Publication
(10) Pub. No.: US 2004/0062067 A1
(43) Pub. Date: Apr. 1, 2004

(54) Adaptor module

(75) Inventors: Ming-Chuan Su, Taipei (TW); Shin-Yi Lo, Taipei (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Arima Computer Corporation, Taipei (TW)

(21) Appl. No.: 10/261,810

(22) Filed: Oct. 1, 2002

(51) Int. Cl. H02M 1/00

(52) U.S. Cl. 363/146

(57) ABSTRACT

An AC/DC adaptor module for preventing from inducing noises is provided. The adaptor for transforming an AC power from a socket having a grounded terminal into a DC power and providing an equipment having an input terminal, a negative terminal and a grounded piece with the DC power, includes a transformer having a positive output terminal and a negative output terminal for being electrically connected to the positive input terminal and the negative input terminal of the equipment respectively, wherein the negative input terminal of the equipment is connected to the grounded piece of the equipment, and a grounded wire having a first terminal electrically connected to the grounded piece of the equipment and a second terminal connected to the grounded terminal of the socket.

### FIELD OF THE INVENTION

The present invention is related to an adaptor module and more particularly, to an AC/DC adaptor module.

### BACKGROUND OF THE INVENTION

As electronic technology evolves, new types of electrical devices with advanced functions are developed. Meanwhile an AC/DC adaptor has become an essential electronic device and is widely applied in a lot of power-transforming electronic equipments, such as a desktop computer, a display, a printer, a notebook computer, a facsimile machine or a Photostat. Usually, the AC/DC adaptor introduces a high-frequency switching technique to harmony with a pulse width modulator (PWM) and an output-filtering circuit, so as to transform the city power (AC power) to a DC power for an IC circuit. The voltage of that transformed DC power can be +5V, +12V, −5V, −12V, +3.3V and so on. However the transformed DC power still includes a little AC parts caused by the original AC power, and the AC parts of the DC power will introduce some noise to influence the output signal of the equipment. Therefore, a DC/DC rectifier is introduced to rectify the transformed DC power for filtering out the AC parts of the DC power, and thereby the rectified DC power can provide the electronic equipment with a stable power. Unfortunately, the rectified DC power consumed by the electronic equipment is variant and easy to induce other noises.

Please refer to FIG. 1. It illustrates a prior AC/DC adaptor applied to a personal computer. The AC/DC adaptor 1 includes a filtering and rectifying circuit 11, a pulse width modulator (PWM) 12, a transformer 13 and a frame ground wire 14. Meanwhile the transformer 13 has a positive output terminal and a negative output terminal for being electrically connected to a positive input terminal and a negative input terminal of a DC/DC rectifier 21 of the personal computer module 2 respectively, and the frame ground wire 14 is connected with the negative output terminal of the transformer 13. FIG. 1 further illustrates a signal-outputting device 3, such as a television or a displaying module, connected to the personal computer module 2 via a video interface or a displaying interface. The signal-outputting device 3 and the AC/DC adaptor module 1 are electrically connected to the same socket. However because the frame ground wire 14 of the AC/DC adaptor module 1 is conducted to the grounded terminal 32 of the signal-outputting device 3 via the grounded terminal 41 of the socket 4, the prior AC/DC adaptor module will induce some noises easily.

As shown in FIG. 1, when external AC/DC adaptor module 1 provides the personal computer 2 with the DC power via the outputting terminals V+ and V−, the current is transmitted from the outputting terminal V+ back to the point a through the DC/DC rectifier 21 of the personal computer 2, and further transmitted to the point b. Meanwhile the DC/DC rectifier 21 of the personal computer 2 provides other internal devices with the rectified DC power, and the rectified DC power consumed by the internal device of the personal computer 2 is variant. When the rectified DC power varies, the voltage between the points a and b will vary, too. On the other hand, the point b to c, and the point e to f are respectively conducted via the ground wire, and the points c and e are conducted via the grounded terminal of the socket 4. The potential of the point b will influence that of the point f directly. Furthermore, the point a and the point g are conducted via a ground piece 23, and the potential of the point a will influence that of g. Thus, the variation of the voltage between the points a and b will induce the voltage between the points g and f, thereby the referring signals of the signal-transmitting device 3 being influenced and the outputting picture or audio of the signal-transmitting device 3 being interfered.

Therefore, it is tried to rectify this drawback and provide an AC/DC adaptor module by the present applicant, but no noise will be induced.

### SUMMARY OF THE INVENTION

It is therefore a primary objective of the present invention to provide an AC/DC adaptor module for preventing from inducing noises.

According to the present invention, the adaptor for transforming an AC power from a socket having a grounded terminal into a DC power and providing an equipment having an input terminal, a negative terminal and a grounded piece with the DC power, includes a transformer having a positive output terminal and a negative output terminal for being electrically connected to the positive input terminal and the negative input terminal of the equipment respectively, wherein the negative input terminal of the equipment is connected to the grounded piece of the equipment, and a grounded wire having a first terminal electrically connected to the grounded piece of the equipment and a second terminal connected to the grounded terminal of the socket.

Preferably, the transformer further includes a filtering and rectifying circuit and a pulse width modulator (PWM).

Certainly, the filtering and rectifying circuit and the pulse width modulator (PWM) can be electrically connected to the grounded wire via a capacitor.

Preferably, the transformer further includes a first polarity capacitor electrically connected in parallel between the filtering and rectifying circuit and the pulse width modulator (PWM).

Preferably, the adaptor further includes a second polarity capacitor having a positive terminal and a negative terminal electrically connected to the positive output terminal and the negative output terminal of the transformer respectively.

Certainly, the grounded piece can be electrically connected to a grounded terminal of an video or display interface of the equipment.

Certainly, the video or display interface can be electrically connected to a signal-outputting device via a signal wire.

Certainly, the signal-outputting device can be provided with a power via the socket.

Preferably, the signal-outputting device further includes a grounded wire connected to the grounded terminal of the socket.

It is therefore a secondary objective of the present invention to provide an AC/DC adaptor module with a buffer circuit for improving the electrical magnetic interference (EMI) and electrostatic discharge (ESD) performance.

Preferably, the adaptor further includes a buffer circuit connected between the negative terminal of the transformer and the grounded wire.

Preferably, the buffer circuit further includes a capacitor and a resistor.

Certainly, the capacitor and the resistor can be in a parallel connection between the negative output terminal of the transformer and the grounded wire.

It is therefore another objective of the present invention to provide a power adaptor for preventing from inducing noises.

It is therefore another objective of the present invention to provide a power adaptor with a buffer circuit for improving the electrical magnetic interference (EMI) and electrostatic discharge (ESD) performance.

According to the present invention, the power adaptor for transforming an AC power of a socket having a grounded terminal into a DC power, includes a transforming module having a positive output terminal and a negative output terminal, a rectifier having a positive input terminal electrically connected to the positive output terminal of the transforming module, a negative input terminal electrically connected to the negative output terminal of the transforming module, and a grounded piece electrically connected to the negative input terminal, and a grounded wire having a first terminal electrically connected to the grounded piece of the equipment and a second terminal electrically connected to the grounded terminal of the socket.

Preferably, the transforming module further includes a transformer.

Certainly, the grounded piece can be electrically connected to a grounded terminal of an video or display interface.

Certainly, the video or display interface can be electrically connected to a signal-outputting device via a signal wire.

Certainly, the signal-outputting device can be provided with a power via the socket.

Preferably, the signal-outputting device further includes a grounded wire electrically connected to the grounded terminal of the socket.

Preferably, the power adaptor further includes a buffer circuit electrically connected between the negative terminal of the transforming module and the grounded wire.

Preferably, the buffer circuit further includes a capacitor and a resistor.

Certainly, the capacitor and the resistor can be in a parallel connection between the negative output terminal of the transforming module and the grounded wire.

The foregoing and other features and advantages of the present invention will be more clearly understood through the following descriptions with reference to the drawings, wherein:

### BRIEF DESCRIPTION OF THE DRAWING

FIG. 1 illustrates a prior AC/DC adaptor applied to a personal computer;

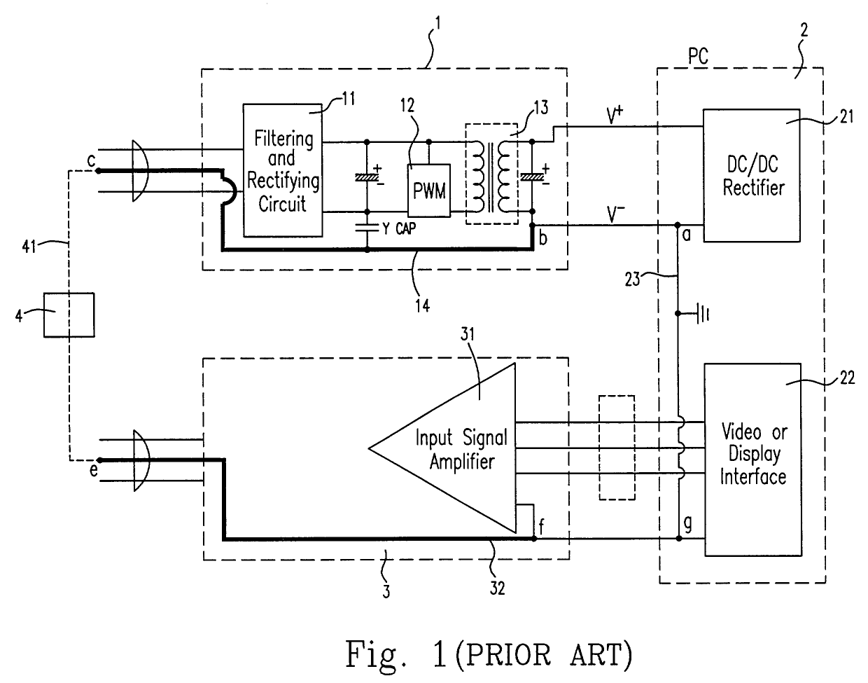

FIG. 2 illustrates a first preferred embodiment of the present invention of the AC/DC adaptor; and

FIG. 3 illustrates a second preferred embodiment of the present invention of the AC/DC adaptor.

### DETAILED DESCRIPTION OF THE PREFERRED EMBODIMENTS

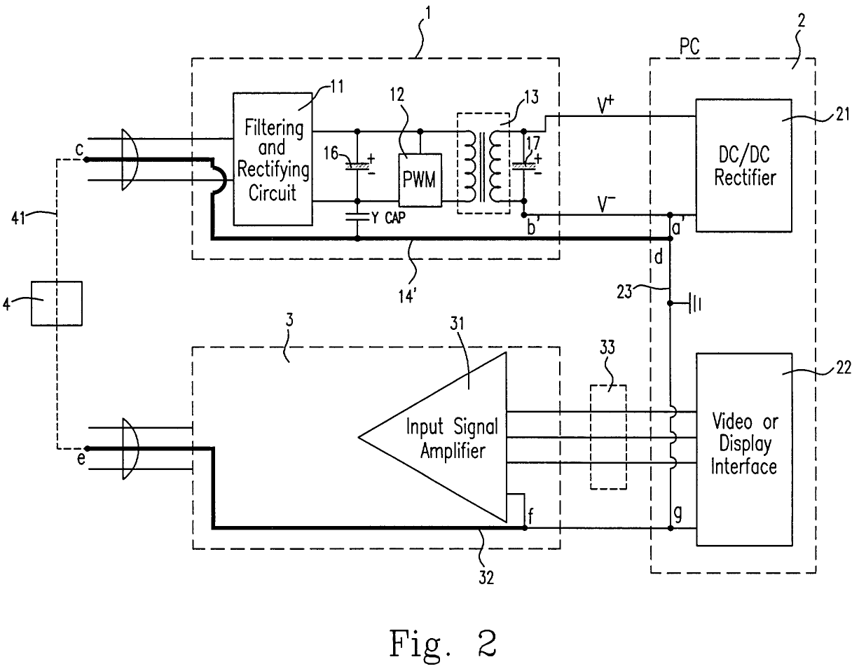

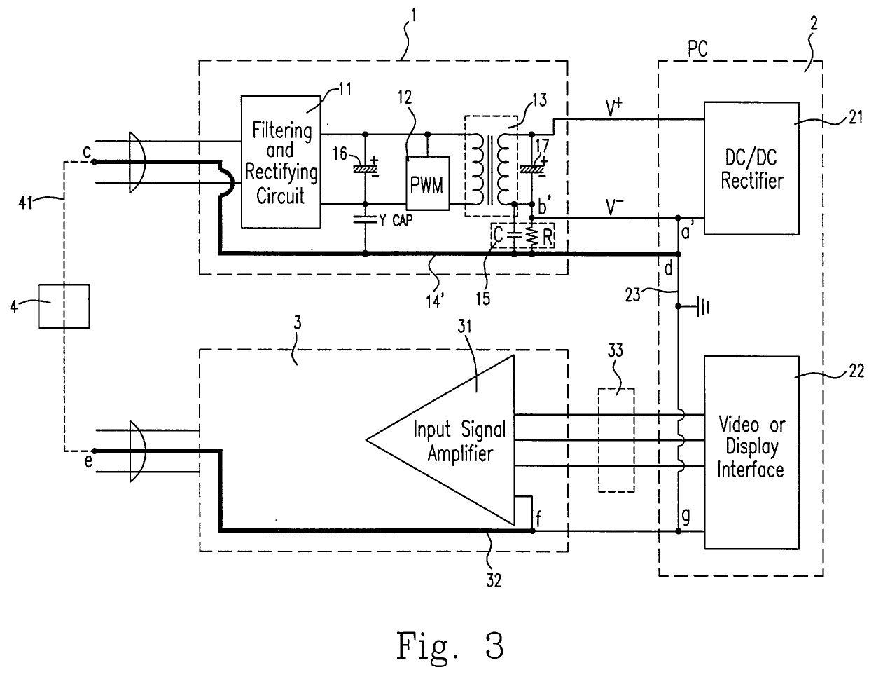

FIG. 2 and FIG. 3 illustrate the first and the second embodiments of the AC/DC adaptor according to the present invention. Please refer to FIG. 2. It illustrates the first preferred embodiment, the AC/DC adaptor 1 for transforming an AC power from a socket 4 into a DC power and providing a personal computer module 2 with the DC power, includes a transformer 13 and a grounded wire 14′. The transformer 13 has a positive output terminal and a negative output terminal b′ for being electrically connected to the positive input terminal and the negative input terminal a′ of the DC/DC rectifier 21 of the personal computer module 2 respectively, wherein the negative input terminal a′ of the DC/DC rectifier 21 of the personal computer module 2 is connected to the grounded piece 23 of the personal computer module 2. The grounded wire 14′ of the adaptor module 1 has a first terminal electrically connected to the grounded piece 23 of the personal computer module 2 at the point d and a second terminal connected to the grounded terminal 41 of the socket 4 at the point c. Certainly, the adaptor module 1 further includes a filtering and rectifying circuit 11 and a pulse width modulator (PWM) 12, wherein the filtering and rectifying circuit 11 and the pulse width modulator (PWM) 12 can be electrically connected to the grounded wire 14′ via a capacitor Y CAP, a first polarity capacitor 16 electrically connected in parallel between the filtering and rectifying circuit 11 and the pulse width modulator (PWM) 12, and a second polarity capacitor 17 having a positive terminal and a negative terminal electrically connected to the positive output terminal and the negative output terminal b′ of the transformer 13 respectively. Furthermore, the grounded piece 23 of the personal computer module 2 is electrically connected to a grounded terminal g of an video or display interface 22 of the equipment and the video or display interface 22 is electrically connected to a signal-outputting device 3 via a signal wire 33. Meanwhile, the signal-outputting device 3 further includes a grounded wire 32 connected to the grounded terminal 41 of the socket 4. Accordingly, when external AC/DC adaptor module 1 provides the personal computer module 2 with the DC power via the outputting terminals V+ and V−, the current is transmitted from the outputting terminal V+ back to the point a′ through the DC/DC rectifier 21 of the personal computer 2, and further transmitted to the point b′. However the potential of the point g is equal to that of the points f, e, c, and a′, and there should be no variation induced between the points g and f, thereby the function of preventing the adaptor from noises being achieved. Moreover, the grounded piece 23 is connected to the points f and g directly for improving the problems of the electrical magnetic interference (EMI) and electrostatic discharge (ESD).

Please refer to FIG. 3. It illustrates a second preferred embodiment of the present invention of the AC/DC adaptor. As shown in FIG. 3, the AC/DC adaptor 1 for transforming an AC power from a socket 4 into a DC power and providing a personal computer module 2 with the DC power, includes a transformer 13, a grounded wire 14′ and a buffer circuit 15. The transformer 13 has a positive output terminal and a negative output terminal b′ for being electrically connected to the positive input terminal and the negative input terminal a′ of a DC/DC rectifier 21 of the personal computer module 2 respectively, wherein the negative input terminal a′ of the DC/DC rectifier 21 is connected to the grounded piece 23 of the personal computer module 2. The grounded wire 14′ of the adaptor module 1 has a first terminal electrically connected to the grounded piece 23 of the personal computer module 2 at the point d and a second terminal connected to the grounded terminal 41 of the socket 4 at the point c. The buffer circuit 15 includes a capacitor C (C≦1 μF) and a resistor R (R≧1 Ω) respectively electrically connected between the negative terminal b′ of the transformer 13 and the grounded wire 14′, wherein the capacitor C and the resistor R are in a parallel connection between the negative output terminal b′ of the transformer 13 and the grounded wire 14′. Certainly, the adaptor module 1 further includes a filtering and rectifying circuit 11 and a pulse width modulator (PWM) 12, wherein the filtering and rectifying circuit 11 and the pulse width modulator (PWM) 12 can be electrically connected to the grounded wire 14′ via a capacitor Y CAP, a first polarity capacitor 16 electrically connected in parallel between the filtering and rectifying circuit 11 and the pulse width modulator (PWM) 12, and a second polarity capacitor 17 having a positive terminal and a negative terminal electrically connected to the positive output terminal and the negative output terminal b′ of the transformer 13 respectively. Furthermore, the grounded piece 23 of the personal computer module 2 is electrically connected to a grounded terminal g of an video or display interface 22 of the equipment and the video or display interface 22 is electrically connected to a signal-outputting device 3 via a signal wire 33. Meanwhile, the signal-outputting device 3 further includes a grounded wire 32 connected to the grounded terminal 41 of the socket 4. Accordingly, when external AC/DC adaptor module 1 provides the personal computer module 2 with the DC power via the outputting terminals V+ and V−, the current is transmitted from the outputting terminal V+ back to the point a′ through the DC/DC rectifier 21 of the personal computer 2, and further transmitted to the point b′. However the potential of the point g is equal to that of the points f, e, c, and a′, and there should be no variation induced between the points g and f, thereby the function of preventing the adaptor from noises being achieved. Moreover, the grounded piece 23 is connected to the points f and g directly for improving the problems of the electrical magnetic interference (EMI) and electrostatic discharge (ESD), and the buffer circuit 15 is introduced into the adaptor module for improving the EMI performance.

Accordingly, the present invention provides an AC/DC adaptor module having a frame ground wire extended and conducted to the personal computer module for preventing the device from noises and improving the electrical magnetic interference (EMI) and electrostatic discharge (ESD) performance by means of adding a specific grounded wire.

While the invention has been described in terms of what are presently considered to be the most practical and preferred embodiments, it is to be understood that the invention need not to be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. An adaptor for transforming an AC power from a socket having a grounded terminal into a DC power and providing an equipment having an input terminal, a negative terminal and a grounded piece with said DC power, comprising:
a transformer having a positive output terminal and a negative output terminal for being electrically connected to said positive input terminal and said negative input terminal of said equipment respectively, wherein said negative input terminal of said equipment is connected to said grounded piece of said equipment; and
a grounded wire having a first terminal electrically connected to said grounded piece of said equipment and a second terminal connected to said grounded terminal of said socket.

2. The adaptor according to claim 1, wherein said transformer further comprises a filtering and rectifying circuit and a pulse width modulator (PWM).

3. The adaptor according to claim 2, wherein said filtering and rectifying circuit and said pulse width modulator (PWM) are electrically connected to said grounded wire via a capacitor.

4. The adaptor according to claim 2 further comprising a first polarity capacitor electrically connected in parallel between said filtering and rectifying circuit and said pulse width modulator (PWM).

5. The adaptor according to claim 1 further comprising a second polarity capacitor having a positive terminal and a negative terminal electrically connected to said positive output terminal and said negative output terminal of said transformer respectively.

6. The adaptor according to claim 1, wherein said grounded piece is electrically connected to a grounded terminal of an video or display interface of said equipment.

7. The adaptor according to claim 6, wherein said video or display interface is electrically connected to a signal-outputting device via a signal wire.

8. The adaptor according to claim 7, wherein said signal-outputting device is provided with a power via said socket.

9. The adaptor according to claim 8, wherein said signal-outputting device further comprises a grounded wire connected to said grounded terminal of said socket.

10. The adaptor according to claim 1 further comprising a buffer circuit connected between said negative terminal of said transformer and said grounded wire.

11. The adaptor according to claim 10, wherein said buffer circuit further comprises a capacitor and a resistor.

12. The adaptor according to claim 11, wherein said capacitor and said resistor are in a parallel connection between said negative output terminal of said transformer and said grounded wire.

13. A power adaptor for transforming an AC power of a socket having a grounded terminal into a DC power, comprising:
a transforming module having a positive output terminal and a negative output terminal;
a rectifier having a positive input terminal electrically connected to said positive output terminal of said transforming module, a negative input terminal electrically connected to said negative output terminal of said transforming module, and a grounded piece electrically connected to said negative input terminal; and
a grounded wire having a first terminal electrically connected to said grounded piece of said equipment and a second terminal electrically connected to said grounded terminal of said socket.

14. The power adaptor according to claim 13, wherein said transforming module further comprises a transformer.

15. The power adaptor according to claim 13, wherein said grounded piece is electrically connected to a grounded terminal of an video or display interface.

16. The power adaptor according to claim 15, wherein said video or display interface is electrically connected to a signal-outputting device via a signal wire.

17. The power adaptor according to claim 16, wherein said signal-outputting device is provided with a power via said socket.

18. The power adaptor according to claim 17, wherein said signal-outputting device further comprises a grounded wire electrically connected to said grounded terminal of said socket.

19. The power adaptor according to claim 13 further comprising a buffer circuit electrically connected between said negative terminal of said transforming module and said grounded wire.

20. The power adaptor according to claim 19, wherein said buffer circuit further comprises a capacitor and a resistor.

21. The power adaptor according to claim 20, wherein said capacitor and said resistor are in a parallel connection between said negative output terminal of said transforming module and said grounded wire.
